(19) United States
(12) Patent Application Publication
(10) Pub. No.: US 2014/0143077 A1
(43) Pub. Date: May 22, 2014

(54) Automated Print and Digital Media and Communications Vending Kiosk

(71) Applicant: Rajesh Shah, Naperville, IL (US)

(72) Inventor: Rajesh Shah, Naperville, IL (US)

(21) Appl. No.: 14/023,232

(22) Filed: Sep. 10, 2013

Related U.S. Application Data
(60) Provisional application No. 61/728,602, filed on Nov. 20, 2012.

(51) Int. Cl. G06Q 20/18

(52) U.S. Cl. CPC G06Q 20/18
USPC 705/21; 705/16; 705/22

(57) ABSTRACT

An automated print and digital media and communications vending kiosk provides products for sale including printer ink cartridges, printer paper, digital media storage and other related products in a standalone unit which may be placed outside of convenience stores or other stores for convenient access by customers.

The current application claims a priority to the U.S. Provisional Patent application Ser. No. 61/728,602 filed on Nov. 20, 2012.

### FIELD OF THE INVENTION

The present invention relates generally to selling products. More particularly, the present invention relates to a kiosk for vending print, digital and communication media products.

### BACKGROUND OF THE INVENTION

Currently, products such as printer ink cartridges, printer toner cartridges, printer paper, memory sticks and blank optical media discs are generally purchased inside specific brick and mortar stores. Customers may be very busy and wish to save time in replenishing their printing or other digital media supply needs. The goal of the present invention is to supply standalone kiosks which may be installed at many convenient locations such as corner grocery stores, convenience stores, and gas stations so that the customer does not have to make a lengthy trip to the proper brick and mortar store to purchase supplies. Ink cartridges for common printers and other such supplies may be dispensed at a competitive price and availability, providing immediate point of sale and delivery satisfaction, 24 hours a day, 7 days a week and around the world. This increases productivity, reduces frustration and provides immediate desired results. The printers and busy individuals are soon back in business, and save money due to price competitiveness.

Printer ink cartridges sold could be new, refurbished or used. The customer can choose various options which may provide flexible solutions for their printing needs. Frequent customers can get discount coupons, and can receive additional discounts for returning their used printer cartridges. The kiosk can also dispense memory sticks, optical media discs and printer papers so that a customer can get a complete package to take care of their printing needs. Transactions and inventory can be monitored in real time through internet or mobile communication technology, and personnel can be dispatched to service kiosks when necessary. Only a small amount of space, electricity and wireless connection is required, and data can also be sent to a manager's cell phone, tablet, other mobile device or personal computer for management.

### BRIEF DESCRIPTION OF THE DRAWINGS

FIG. 1 is a front view of one embodiment of the present invention.

FIG. 2 is an elevated perspective view of the present invention with internal components shown as dashed lines.

FIG. 3 is an elevated perspective view of the present invention with internal components shown as dashed lines.

FIG. 4 is a front view of the present invention with internal components shown as dashed lines.

FIG. 5 is a side view of the present invention with internal components shown as dashed lines.

FIG. 6 is a block diagram of electrical connections between the power source and other electrical components.

FIG. 7 is a block diagram of electronic connections between the chipset source and other electronic components.

FIG. 8 is a stepwise flow diagram describing an overall method for operating the present invention.

FIG. 9 is a stepwise flow diagram describing the method step for inventory management of the present invention.

FIG. 10 is a stepwise flow diagram describing the method step for maintenance management of the present invention.

FIG. 11 is a stepwise flow diagram describing the method step for receiving an instruction from a management server.

FIG. 12 is a stepwise flow diagram describing the method step for displaying a sold out message to a customer.

### DETAIL DESCRIPTIONS OF THE INVENTION

All illustrations of the drawings are for the purpose of describing selected versions of the present invention and are not intended to limit the scope of the present invention.

The present invention is an automated standalone vending kiosk for selling and dispensing print and digital media and communications products. Examples of such products include, but are not limited to, printer ink cartridges, printer toner cartridges, digital video discs (DVDs), blank compact discs (CDs) and other optical media storage, printer paper, and flash memory sticks. Additional products to be sold using the present invention may include cell phone cover cases, cell phone screen protectors, handheld music players, prepaid phone cards and prepaid cards from other companies such as Google or Amazon. Another product to be contemplated as potentially one of the plurality of products is cameras. The cameras may be digital cameras, film cameras, disposable cameras or another type of camera. The goal of the present invention is to provide such products at a competitive price at convenient point of sale locations such as outside convenience stores, grocery stores, super stores, stationary stores, gas stations or other locations. The present invention provides a quick and easy solution for individuals who need to replenish printer supplies such as ink cartridges or printer paper or other media supplies such as blank DVDs or memory sticks. The present invention is a convenient solution for busy individuals who lack necessary supplies and need to be back in business quickly. Additionally, the present invention is intended to provide customers with significant savings on the products they need. Products can be provided without costs associated with brick and mortar print or digital media stores, such as typical overhead like heating, ventilation and air conditioning, lighting, electricity and paying employees to operate a store. The present invention can provide a large volume of sales to customers without these costs and therefore can offer products at significantly reduced prices compared to brick and mortar stores.

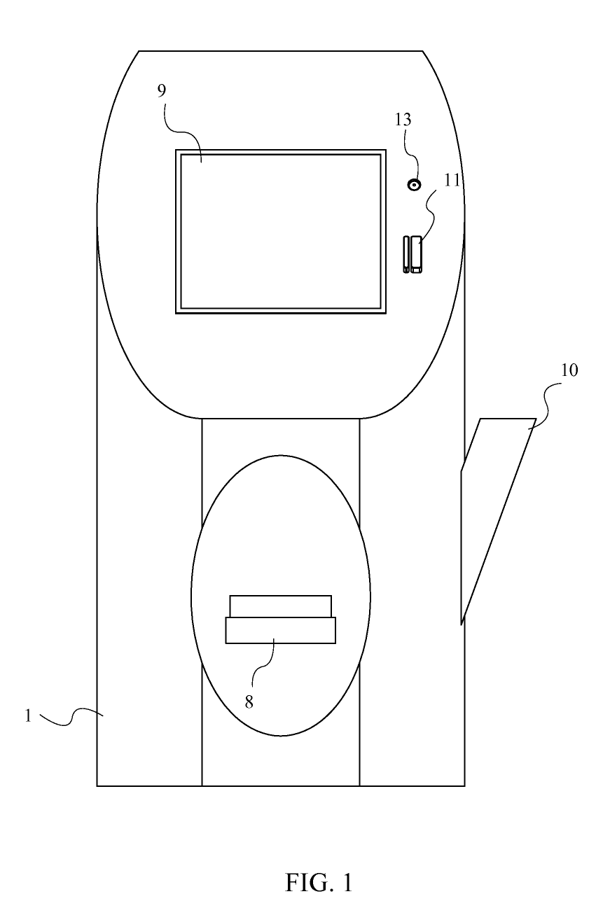

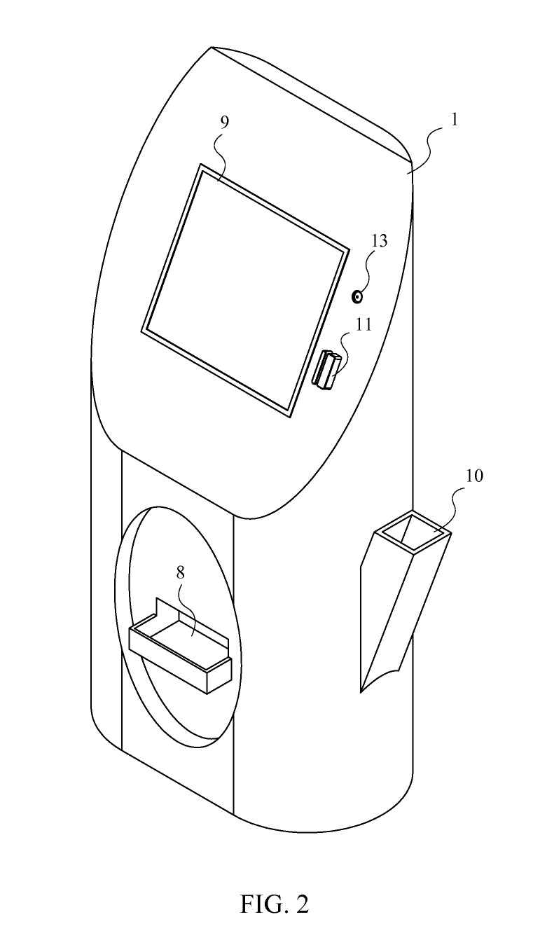

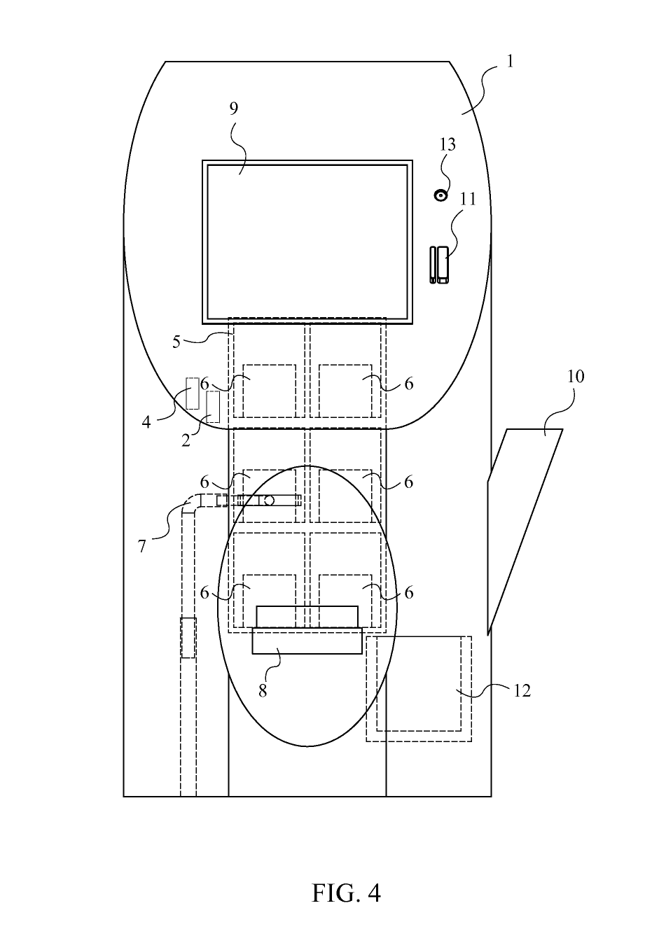

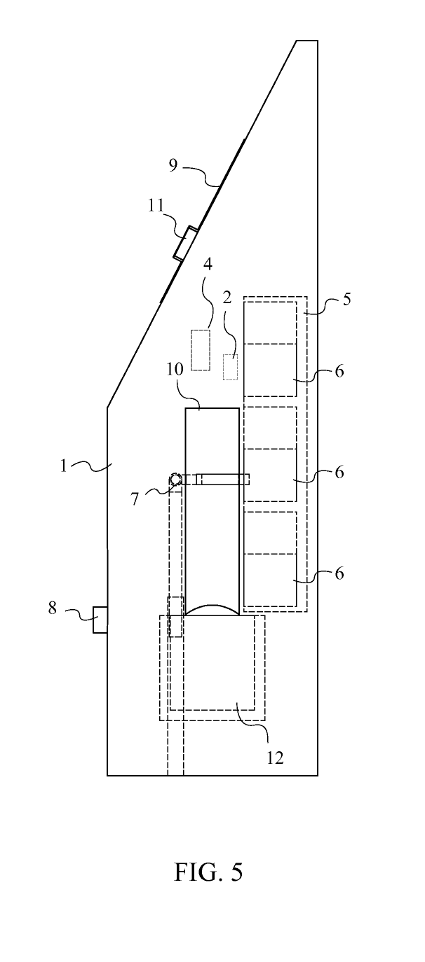

Referring to FIGS. 1-5, the present invention comprises a housing 1, a chipset 2, a power source 3, a wireless communication device 4, a product storage rack 5, a product delivery mechanism 7, a product distribution tray 8, a user interface 9, a used cartridge acceptor 10, a payment acceptor 11, and a security camera 13.

The housing 1 is an external shell for the present invention, concealing all inner components and supporting various external components. The housing 1 may be made from any appropriate material or process, but is preferably substantially made from injection molded or welded metal. Since the present invention is intended to be positioned outside a building and exposed to the elements, the housing 1 should be made from or coated with a material that protects the housing 1 from wear and tear due to weather, animals or other sources of disrepair.

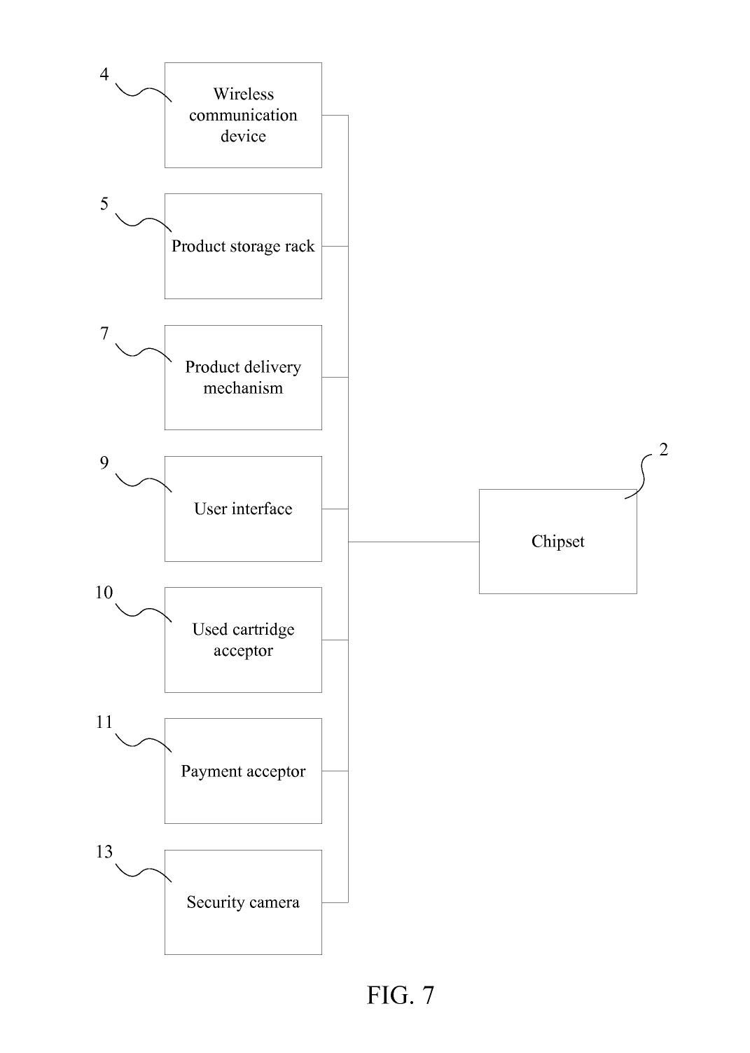

The chipset 2 is a component or combination of components of the electronic variety such as, but not limited to, circuit boards, wires, and processors necessary to facilitate the translation of electrical input signals into desired effects in the operation of the system. The chipset 2 receives electrical inputs from various sources, such as, but not limited to, the wireless communication device 4, the product storage rack 5, the product delivery mechanism 7, the user interface 9, the used cartridge acceptor 10, and the payment acceptor 11, processes the inputs, and produces appropriate outputs, such as, but not limited to, signals to display various information on the user interface 9, signals to activate the product delivery mechanism 7, signals to play audio through a speaker, or commands through a network connection to perform functions such as, but not limited to, sending a status notification to a management server, sending an email, or adding an email address, phone number or other information to a database, where said information would be received through the user interface 9. The chipset 2 is positioned within the housing 1 in any appropriate location, and is electrically connected to the power source 3. The chipset 2 electronically receives input from or sends input to the wireless communication device 4, the product storage rack 5, the product delivery mechanism 7, the user interface 9, the used cartridge acceptor 10, and the payment acceptor 11. The specific position of the chipset 2 is not of particular importance as long as the chipset 2 is able to be connected to the appropriate components and is protected from damage. Electronic connections for the chipset 2 are illustrated in FIG. 7.

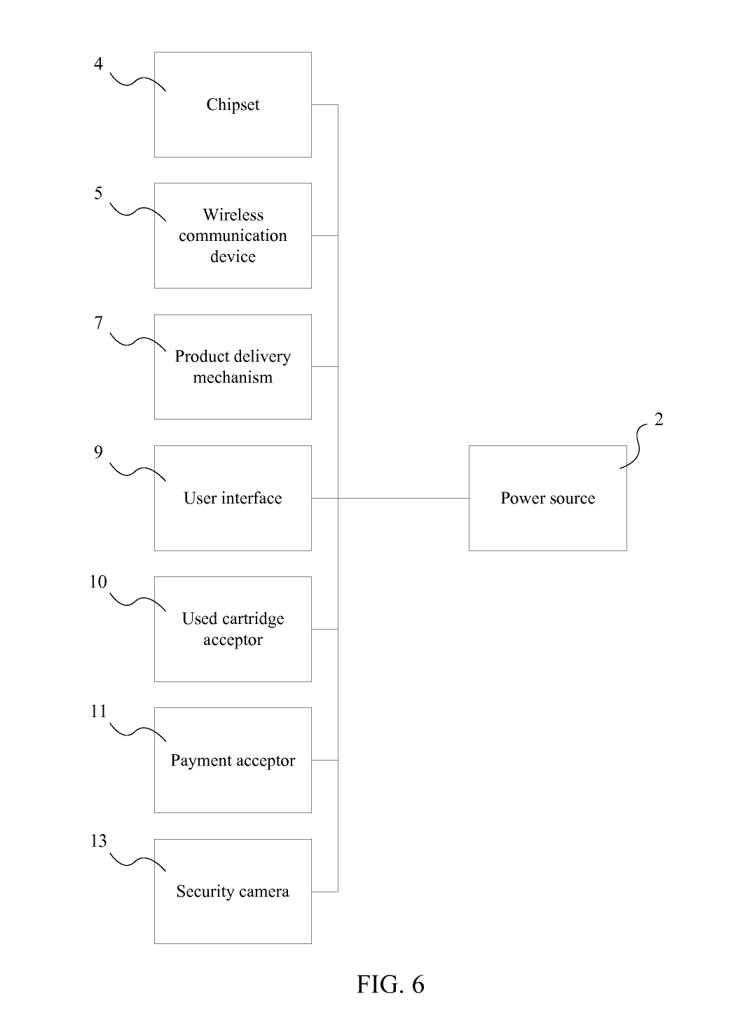

The power source 3 is preferably a wired connection to a standard 125 volt, 15 amp electrical outlet common in North America, although any other electrical outlet may be used if applicable. In an alternate embodiment of the present invention, the power source 3 additionally comprises a battery pack so that the present invention may continue to operate in the event of an electrical blackout. Electrical connections for the power source 3 are illustrated in FIG. 6.

In the preferred embodiment of the present invention, the wireless communication device 4 is a well-known electronic device that enables data transmission over a computer network via radio waves, preferably utilizing the Institute of Electrical and Electronics Engineers' 802.11 standards. An alternate embodiment of the present invention further comprises a wired network connection such as an ethernet port. The present invention may transmit data to and from the management server or other entities through the wireless communication device 4 or the ethernet port. In the preferred embodiment of the present invention, the wireless communication device 4 belongs to a category known as Tri-Fi, which incorporates technologies such as, but not limited to, fourth generation mobile communication technology or new mobile communication technology, Wi-Fi and WiMax. In alternate embodiments, the wireless communication device 4 utilizes any other appropriate wireless communication technologies, such as, but not limited to, Bluetooth. The wireless communication device 4 is preferably positioned within the housing 1, is electrically connected to the power source 3, and is electronically connected to the chipset 2. The specific position of the wireless communication device 4 is not of particular importance as long as the wireless communication device 4 is able to be connected to the power source 3 and the chipset 2 and the wireless communication device 4 is protected from damage. In an alternate embodiment, the wireless communication device 4 is an antenna situation atop the housing 1.

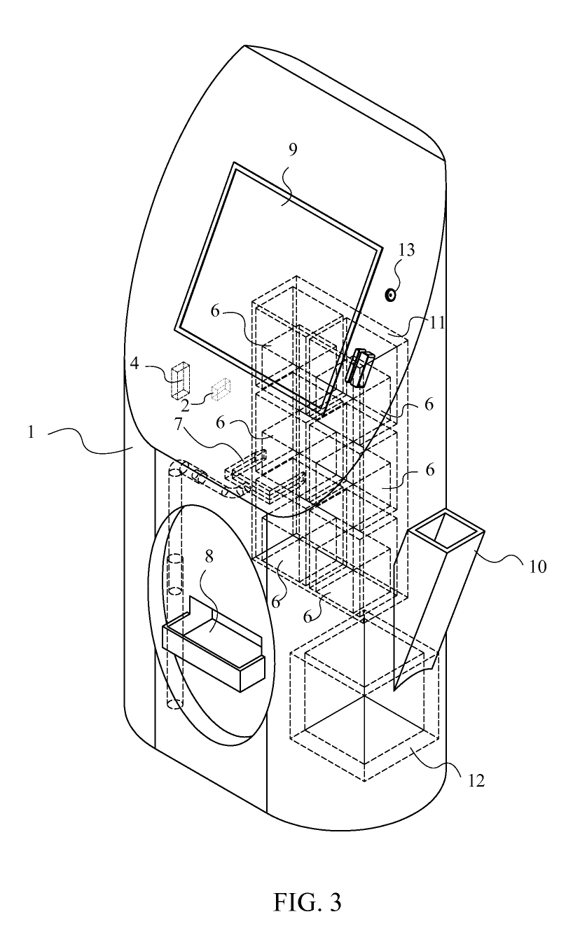

Referring to FIGS. 3-5, the product storage rack 5 is a structure positioned within the housing 1 that accommodates storage for a plurality of products 6 as previously described which a user can purchase. The product storage rack 5 is not specifically defined herein may take any number of different embodiments, provided that the product storage rack 5 is of a physical structure that correctly accommodates the plurality of products 6 and allows for the plurality of products 6 to be removed from the product storage rack 5 for vending. In one embodiment of the present invention, the product storage rack 5 is electronically connected to the chipset 2, so that the chipset 2 may receive input from or send output to the product storage rack 5.

In the preferred embodiment of the present invention, the plurality of products 6 includes, but is not limited to, printer ink cartridges, printer toner cartridges, blank digital media storage such as, but not limited to, blank optical storage discs and flash memory sticks, and blank printer paper. The plurality of products 6 preferably also includes cell phone cover cases, cell phone screen protectors, portable handheld music players to store and play music, prepaid phone and international phone cards, and Google play cards.

The product delivery mechanism 7 positioned within the housing 1, and is any mechanism that works mechanically together with the product storage rack 5 to move one of more of the plurality of products 6 from the product storage rack 5 to the product distribution tray 8 upon completion of a purchase. The product delivery mechanism 7 is also not specifically defined herein, since a number of different embodiments of the product delivery mechanism 7 may serve the same function for the present invention. The product delivery mechanism 7 is electronically connected to the chipset 2, and is electrically connected to the power source 3, so that upon completion of a purchase the chipset 2 can send a command to activate the product delivery mechanism 7 to deliver one of the plurality of products 6 to the product distribution tray 8.

The product distribution tray 8 is simply a tray or similar open-faced container that traverses into the housing 1 and serves to hold a product the user has purchased after the product delivery mechanism 7 has removed moved the product from the product storage rack 5.

The user interface 9 is how the user interacts with the present invention in order to purchase a product. In the preferred embodiment of the present invention, the user interface 9 is a digital touch screen. In alternate embodiments of the present invention, the user interface 9 additionally comprises physical interface components such as, but not limited to, a keyboard, a mouse, or physical buttons. The user interface 9 is positioned on the housing 1, preferably at a height which is comfortable for a user of average height to interact with the user interface 9. The user interface 9 is electrically connected to the power source 3, and is electronically connected to the chipset 2 so that the chipset 2 can receive input from and send output to the user interface 9.

The used cartridge acceptor 10 is a physical structure that traverses into the housing 1 and may accept used printer cartridges from a user. This can provide an advantage to the user by offering a discount on future purchases for returning used cartridges, and promotes recycling of cartridges. The specific physical form of the used cartridge acceptor 10 is not of particular importance, and any physical form of the used cartridge acceptor 10 that allows printer cartridges to be inserted may be embodied in the present invention. In one embodiment of the present invention, the used cartridge acceptor 10 is electrically connected to the power source 3 and electronically connected to the chipset 2 and uses an electrically activated mechanism to deliver an inserted cartridge to a used cartridge reservoir 12. In an alternate embodiment, the used cartridge acceptor 10 is a chute that the user drops a used cartridge into so that the used cartridge lands in the used cartridge reservoir 12. The used cartridge acceptor 10 may be positioned in any convenient location on the housing 1, but is preferably positioned on a lateral side of the housing 1. Preferably, the used cartridge acceptor 10 utilizes a cartridge sensor such as a weight sensor or a light beam interruption sensor to determine when a used cartridge has been inserted.

Similarly, the payment acceptor 11 is a physical structure that is positioned on the housing 1 which accepts payment from the user in order to complete a transaction. The specific physical form of the payment acceptor 11 is not important except that it is capable of accepting payment. In the preferred embodiment of the present invention, the payment acceptor 11 only accepts credit cards, debit cards or similar cards. In alternate embodiments of the present invention, the payment acceptor 11 may also accept physical money such as dollar bills and coins. The payment acceptor 11 is electrically connected to the power source 3 and is electronically connected to the chipset 2. The payment acceptor 11 may be positioned in any convenient location on the housing 1, preferably adjacent to the user interface 9.

The security camera 13 is preferably any digital image capturing device as commonly used for video monitoring. The security camera 13 should be positioned on the housing 1 adjacent or near to the payment acceptor in order to maintain security and prevent vandalism. The security camera 13 is electrically connected to the power source 3 and is electronically connected to the chipset 2.

The chipset 2, the wireless communication device 4, the product storage rack 5, and the product delivery mechanism 7 are positioned within the housing 1. The user interface 9 and the payment acceptor 11 are positioned on the housing 1. The product distribution tray 8 and the used cartridge acceptor 10 traverse into the housing 1.

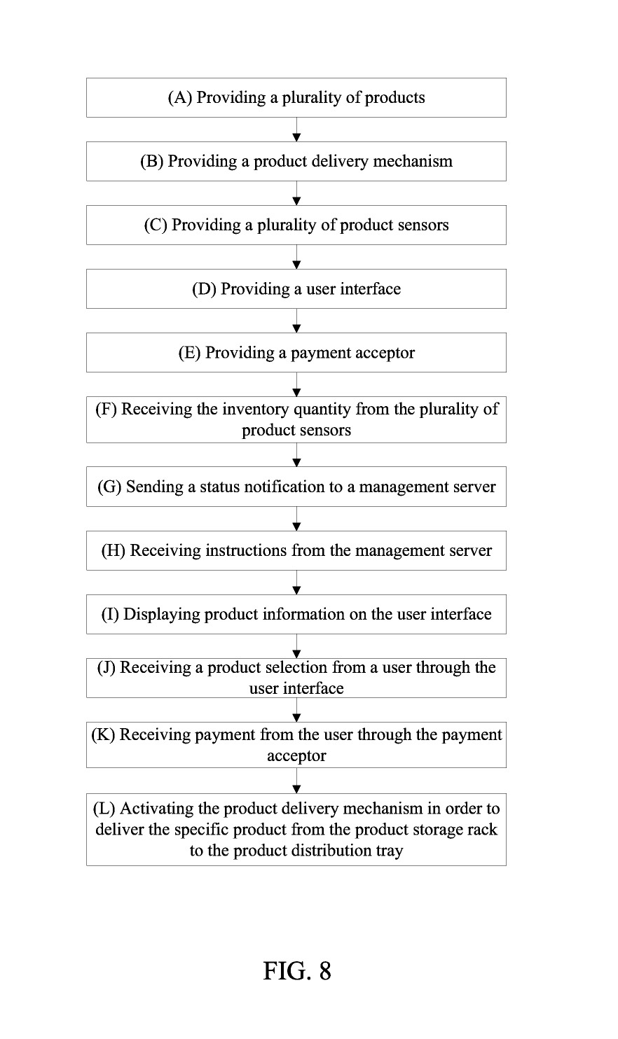

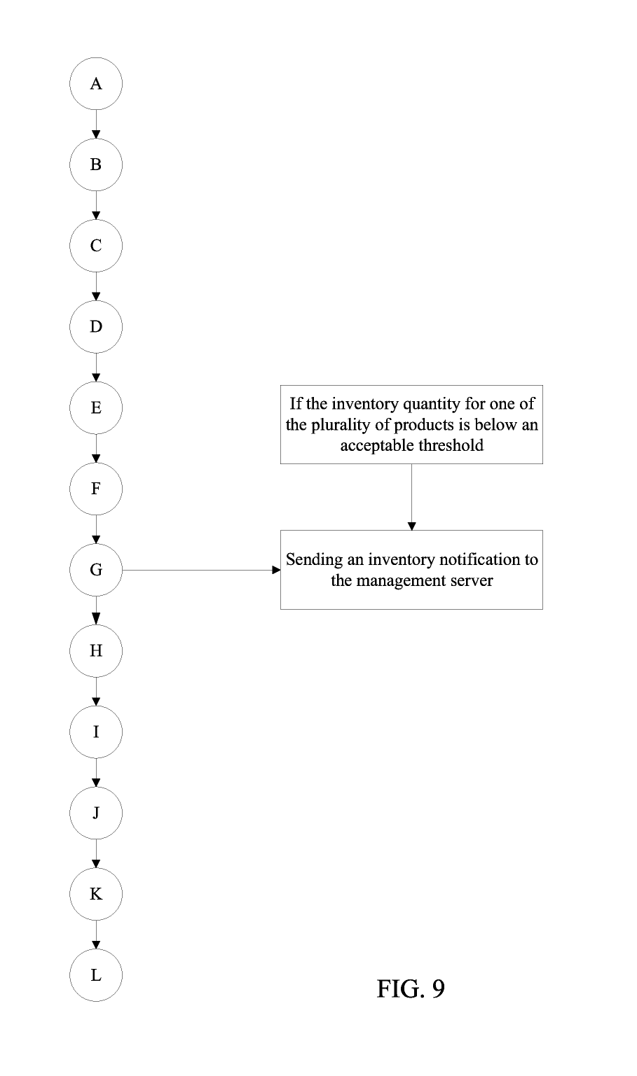

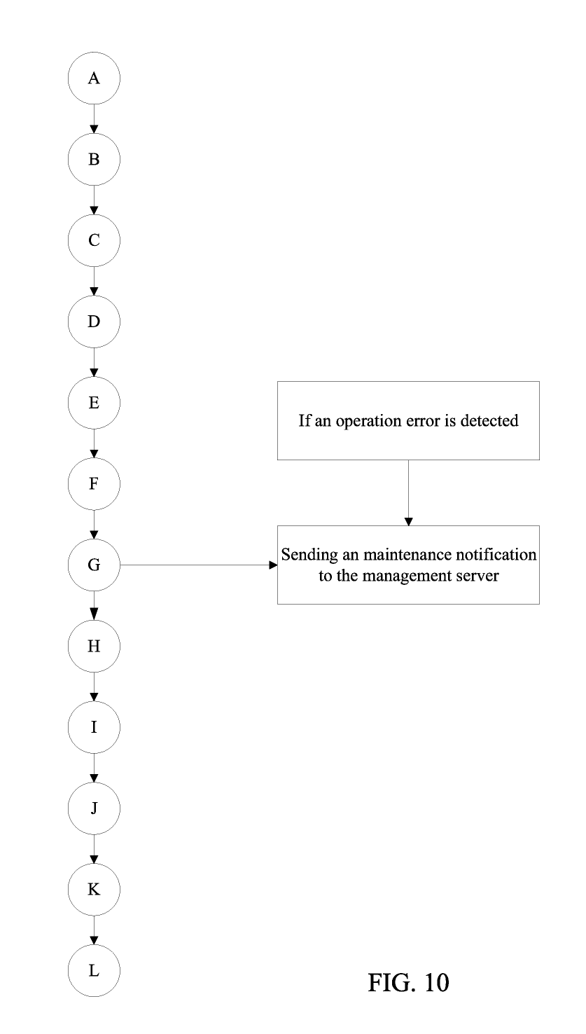

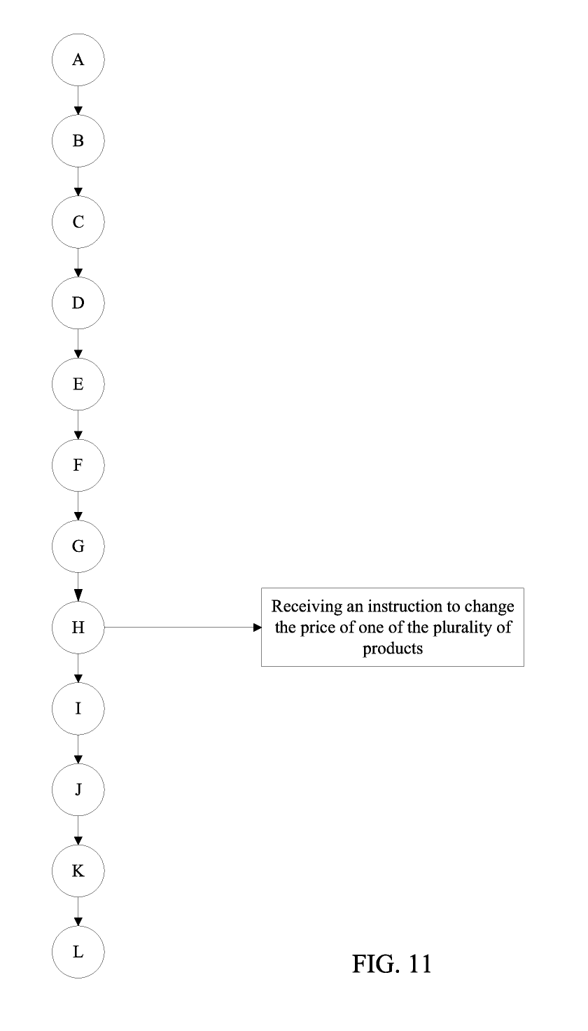

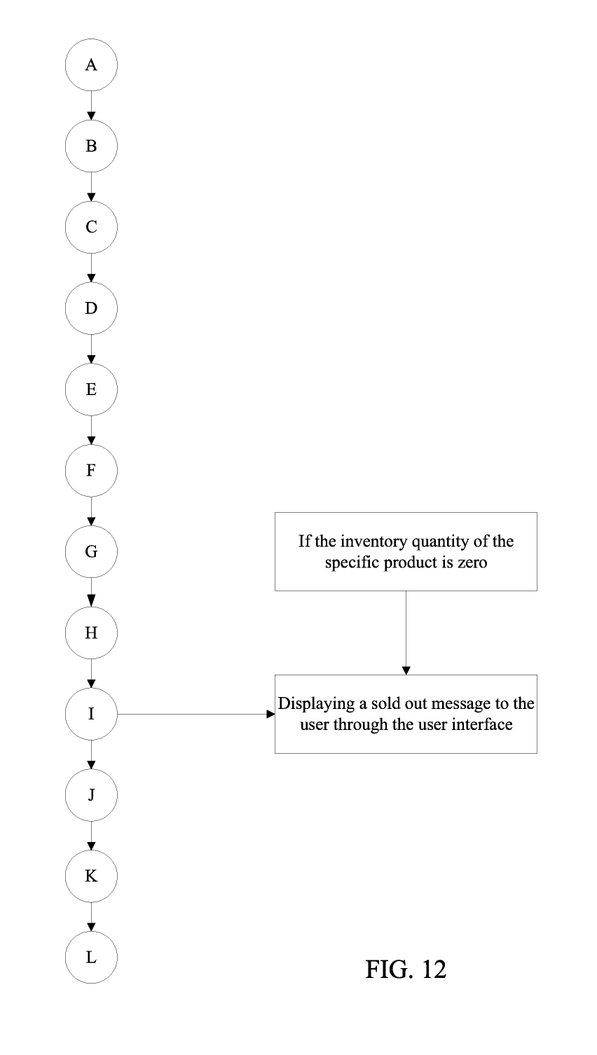

Referring to FIGS. 8-12, a method for operation of the present invention is as follows. The plurality of products 6 is provided, wherein the plurality of products 6 is stored within the product storage rack 5. The product delivery mechanism 7 is provided, wherein the product delivery mechanism 7 moves one or more of the plurality of products 6 from the product storage rack 5 to the product distribution tray 8 upon completion of a purchase. A plurality of product sensors is provided, wherein the plurality of product sensors detect an inventory quantity for each of the plurality of products 6. The user interface 9 and the payment acceptor 11 are also provided.

The chipset 2 receives the inventory quantity from the plurality of product sensors. When necessary, the chipset 2 sends a status notification to a management server. The status notification may be an inventory notification, if the inventory quantity for one of the plurality of products 6 is below an acceptable threshold, wherein the inventory quantity is detected by the plurality of product sensors. The status notification may also be a maintenance notification which is sent if an operation error is detected, wherein the operation error is detected by at least one error detection sensor. Once a status notification is received, personnel can be dispatched immediately to take care of the situation, whether the situation is low inventory or an operating error. The chipset 2 may also receive instructions from the management server, such as, but not limited to, an instruction to change the price of one of the plurality of products 6.

The chipset 2 sends commands to the user interface 9 to displaying items such as, but not limited to, a welcome screen and product information. The user makes a product selection which the chipset 2 receives through the user interface 9, wherein the product selection corresponds to a specific product from the plurality of products 6. The user then inserts payment, which is received through the payment acceptor 11. The product delivery mechanism 7 is then activated in order to deliver the specific product from the product storage rack 5 to the product distribution tray 8. If the inventory quantity of the specific product is zero, a sold out message is displayed to the user through the user interface 9.

Although the invention has been explained in relation to its preferred embodiment, it is to be understood that many other possible modifications and variations can be made without departing from the spirit and scope of the invention as hereinafter claimed.

What is claimed is:

1. An automated print and digital media and communications vending kiosk comprises:
a housing;
a chipset;
a power source;
a wireless communication device;
a product storage rack, wherein the product storage rack accommodates storage for a plurality of products;
a product delivery mechanism;
a product distribution tray;
a user interface, wherein the user interface allows a user to purchase one or more of the plurality of products;
a used cartridge acceptor;
a payment acceptor;
the chipset, the wireless communication device, the product storage rack, and the product delivery mechanism being positioned within the housing;
the user interface and the payment acceptor being positioned on the housing; and
the product distribution tray and the used cartridge acceptor traversing into the housing.

2. The system for an automated print and digital media and communications vending kiosk as claimed in claim 1 comprises:
the chipset, the wireless communication device, the product delivery mechanism, the user interface, the used cartridge acceptor, and the payment acceptor being electrically connected to the power source.

3. The automated print and digital media and communications vending kiosk as claimed in claim 1 comprises:
the wireless communication device, the product storage rack, the product delivery mechanism, the user interface, the used cartridge acceptor, and the payment acceptor being electronically connected to the chipset,
wherein the chipset electronically receives input from or sends input to the wireless communication device, the product storage rack, the product delivery mechanism, the user interface, the used cartridge acceptor, and the payment acceptor.

4. The automated print and digital media and communications vending kiosk as claimed in claim 1, wherein the product delivery mechanism moves one or more of the plurality of products from the product storage rack to the product distribution tray upon completion of a purchase.

5. The system for an automated print and digital media and communications vending kiosk as claimed in claim 1, wherein used printer ink cartridges may be inserted into the cartridge acceptor.

6. The automated print and digital media and communications vending kiosk as claimed in claim 1, wherein the user interface is a digital touch screen.

7. The automated print and digital media and communications vending kiosk as claimed in claim 1, wherein the plurality of products includes printer ink cartridges.

8. The automated print and digital media and communications vending kiosk as claimed in claim 1, wherein the plurality of products includes printer toner cartridges.

9. The automated print and digital media and communications vending kiosk as claimed in claim 1, wherein the plurality of products includes blank digital media storage.

10. The automated print and digital media and communications vending kiosk as claimed in claim 9, wherein the blank digital media storage includes blank optical storage discs and flash memory sticks.

11. The system for an automated print and digital media and communications vending kiosk as claimed in claim 1, wherein the plurality of products includes blank printer paper.

12. A method for operating an automated print and digital media and communications vending kiosk comprises the steps of:
providing a plurality of products, wherein the plurality of products is stored within a product storage rack;
providing a product delivery mechanism, wherein the product delivery mechanism moves one or more of the plurality of products from the product storage rack to a product distribution tray upon completion of a purchase;
providing a plurality of product sensors, wherein the plurality of product sensors detect an inventory quantity for each of the plurality of products;
providing a user interface;
providing a payment acceptor;
receiving the inventory quantity from the plurality of product sensors;
sending a status notification to a management server;
receiving instructions from the management server;
displaying product information on the user interface;
receiving a product selection from a user through the user interface,
wherein the product selection corresponds to a specific product from the plurality of products;
receiving payment from the user for the product selection through the payment acceptor; and
activating the product delivery mechanism in order to deliver the specific product from the product storage rack to the product distribution tray.

13. The method for operating an automated print and digital media and communications vending kiosk as claimed in claim 12 comprises the step of:
sending an inventory notification to the management server,
if the inventory quantity for one of the plurality of products is below an acceptable threshold.

14. The method for operating an automated print and digital media and communications vending kiosk as claimed in claim 12 comprises the step of:
sending a maintenance notification to a management server,
if an operation error is detected,
wherein the operation error is detected by at least one error detection sensor.

15. The method for operating an automated print and digital media and communications vending kiosk as claimed in claim 12 comprises the step of:
receiving an instruction to change the price of one of the plurality of products.

16. The method for operating an automated print and digital media and communications vending kiosk as claimed in claim 12 comprises the steps of:
displaying a sold out message to the user through the user interface,
if the inventory quantity of the specific product is zero.
